(19) United States
(12) Patent Application Publication
(10) Pub. No.: US 2026/0279621 A1
(43) Pub. Date: Sep. 17, 2026

(54) RESISTOR

(71) Applicant: SEMITEC Corporation, Tokyo (JP)

(72) Inventors: Kenji ITO, Tokyo (JP); Daiki SHIMAZAKI, Tokyo (JP); Tadashi TOYODA, Tokyo (JP); Yuji JUMONJI, Tokyo (JP)

(21) Appl. No.: 19/473,991

(22) PCT Filed: Apr. 2, 2024
(86) PCT No.: PCT/JP2024/013595

§ 371 Date: Oct. 9, 2025

(30) Foreign Application Priority Data
Apr. 10, 2023 (JP) 2023-063381

(51) Int. Cl. H01C 1/028; H01C 1/14; H01C 7/00

(52) U.S. Cl. CPC H01C 1/028; H01C 1/14; H01C 7/006

(57) ABSTRACT

To provide a resistor comprising an inorganic material substrate that facilitates measurement of a temperature of a curved surface and suppresses deformation within an operating temperature range.

The above-described problem is solved by a resistor (1) comprising an inorganic material substrate (2) that has insulation properties, flexibility, and a thickness dimension of 1 μm to 100 μm, and suppresses deformation due to phase transition within an operating temperature range, a resistive film (4) formed on the inorganic material substrate (2), at least one pair of electrode layers (3a) and (3b) electrically connected to the resistive film (4), and a protective film (5) that covers a region where the resistive film (4) is formed and forms an exposed portion so that at least part of the at least one pair of electrode layers (3a) and (3b) is exposed.

### FIELD OF THE INVENTION

The present invention relates to a resistor capable of achieving thickness reduction.

### BACKGROUND ART

Electronic components such as thermosensitive resistance elements are used as resistors in electronic devices including information and communication devices such as mobile communication terminals and personal computers, as well as wearable devices, medical devices, consumer devices, automotive electrical devices, and the like.

Recently, there has been a demand for reducing thicknesses of such electronic devices and, with constraints on thickness dimensions of electronic devices, development for achieving both thickness reduction and degradation suppression of electronic components is underway.

For example, preparation of resistors by using ultrathin substrates having thickness dimensions of 100 μm or less has been proposed (refer to Patent Document 1). However, in addition to reducing the thickness dimension of the substrate, there are demands for having substrate flexibility and suppressing substrate degradation, specifically for suppressing substrate deformation within an operating temperature range. Generally, in a case of fabricating a thin-film thermistor having high heat resistance by using an ultrathin substrate of an inorganic material having a thickness dimension of 100 μm or less, the substrate readily cracks due to high-temperature processes during processing, making manufacture impossible in many cases.

As an excellent technology at the present time, a thin-film thermistor having transparent characteristics that realizes a heat resistance temperature of 150° C. by using a glass substrate has been disclosed (refer to Patent Document 2).

### PRIOR ART DOCUMENTS

### Patent Documents

Patent Document 1: Japanese Patent No. 6225295 Patent Document 2: Japanese Laid-Open Patent Application Publication No. 2021-131379

### SUMMARY OF THE INVENTION

### Problems to be Solved by the Invention

However, for the glass substrate described in Patent Document 2, specific thickness dimensions and characteristics of the substrate are not disclosed.

Embodiments of the present invention have been made in view of such problems as described above, and an object thereof is to provide a resistor including an inorganic material substrate that has a heat resistance temperature of 200° C. or more, facilitates measurement of a temperature of a curved surface, for example, and suppresses deformation within an operating temperature range.

### Means for Solving the Problems

A resistor according to an embodiment of the present invention comprises an inorganic material substrate that has insulation properties, flexibility, and a thickness dimension of 1 μm to 100 μm, and suppresses deformation due to phase transition within an operating temperature range, a resistive film formed on the inorganic material substrate, at least one pair of electrode layers electrically connected to the resistive film, and a protective film that covers a region where the resistive film is formed and forms an exposed portion so that at least part of the at least one pair of electrode layers is exposed.

As the inorganic material substrate, a glass substrate or a ceramic substrate can be applied.

According to such an invention, it is possible to obtain an inorganic material substrate that facilitates measurement of a temperature of a curved surface, for example, and suppresses deformation within an operating temperature range.

### Effect of the Invention

It is possible to provide a resistor reduced in thickness and including an inorganic material substrate that has flexibility and suppresses deformation within an operating temperature range.

### BRIEF DESCRIPTION OF THE DRAWINGS

FIG. 1 is a plan view illustrating a resistor according to an embodiment of the present invention.

FIG. 2 is a sectional view illustrating the same resistor.

FIG. 3 is a plan view illustrating the resistor according to another embodiment of the present invention.

FIG. 4 is a sectional view illustrating the same resistor.

FIG. 5 is a microscope image showing an evaluation result of the resistor according to the embodiment of the present invention.

FIG. 6 is, similarly, a microscope image showing an evaluation result.

FIG. 7 is a table showing evaluation results of a glass substrate and a zirconia substrate of the same resistor.

FIG. 8 is a table showing evaluation results in cases of forming and not forming a protective film in the same resistor.

FIG. 9 is a table showing water vapor and oxygen permeabilities of the glass substrate and typical resin films, in the same resistor.

FIG. 10 is a table showing effects in a case of forming the protective film on the glass substrate in the same resistor.

FIG. 11 is a table showing evaluation results of various forms of forming the protective film on the glass substrate, in the same resistor.

FIG. 12 is a table showing evaluation results of ceramic materials.

FIG. 13 is a microscope image showing an evaluation result of a resistor with a zirconia substrate.

FIG. 14 is, similarly, a microscope image showing an evaluation result of a resistor with a zirconia substrate.

### EMBODIMENTS OF THE INVENTION

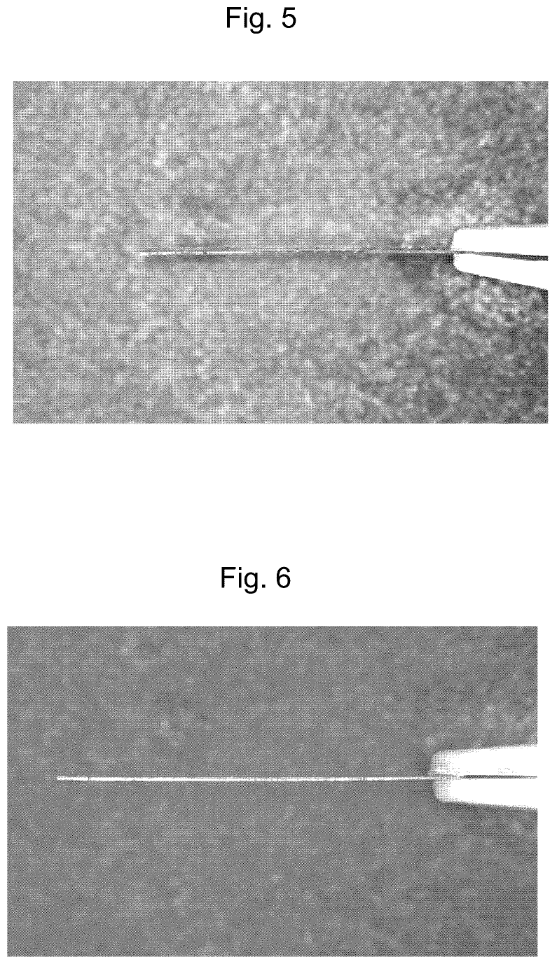

A resistor according to the embodiment of the present invention will now be described with reference to the drawings. First, the prior art (refer to Patent Document 1) will be described. FIG. 5 of Patent Document 1 (FIG. 12 in this application) shows evaluation results of whether fabrication of an insulating substrate having a thickness dimension of 50 μm is possible with ceramic materials. According to these evaluation results, Sample No. 5 is zirconia and has an average particle size after sintering of 0.5 μm and a bending strength of 1,200 MPa, and thus realization of an ultrathin insulating substrate having flexibility can be expected.

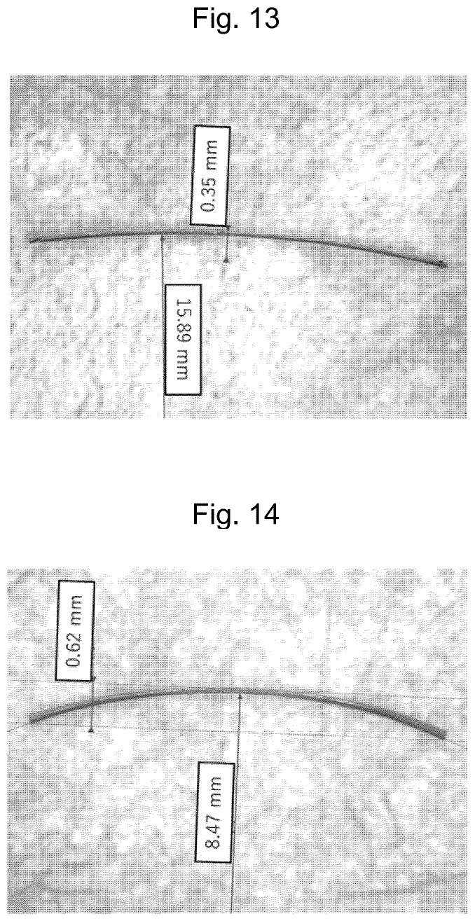

However, it was found that deformation occurs when a resistor with a zirconia substrate is left, for example, within an operating temperature range of the resistor. FIG. 13 shows a microscope image of a resistor with a zirconia substrate observed from a side surface after being left under a 150° C. temperature environment for 1,000 hours. Further, FIG. 14 shows a microscope image of a resistor with a zirconia substrate observed from a side surface after being left under a 200° C. temperature environment for 200 hours.

In FIG. 13, it can be seen that the substrate is deformed with a radius of curvature of 15.89 mm and a convex arc-shaped deformation amount of 0.35 mm. Further, in FIG. 14, it can be seen that the substrate is deformed with a radius of curvature of 8.47 mm and a convex arc-shaped deformation amount of 0.62 mm. Such deformation makes the substrate brittle and causes degradation, reducing strength.

This deformation of the substrate is considered to be deformation due to phase transitions of zirconia. Zirconia has a monoclinic crystal system at room temperature, but a crystal structure thereof undergoes phase transitions to a tetragonal crystal at approximately 1,170° C. and to a cubic crystal at approximately 2,200° C. Accordingly, a zirconia substrate may be damaged under a temperature environment with repeated heating and cooling cycles.

Commonly used zirconia substrates are partially stabilized zirconia substrates. Partially stabilized zirconia substrates are stabilized when yttrium oxide (Y₂O₃) and the like are solutionized. However, with phase transitions occurring under temperature environments of about 200° C., such zirconia substrates deteriorate due to the phase transition from the tetragonal crystal to the monoclinic crystal, reducing strength, as previously mentioned.

However, as a result of various investigations, knowledge was obtained that the phase transition can be suppressed by solutionizing rare earth oxides such as cerium oxide (CeO₂) in the zirconia substrate, which is an inorganic material substrate. Accordingly, it was found that, even with a zirconia substrate, which is a ceramic substrate as an inorganic material substrate, a substrate capable of suppressing degradation caused by phase transition can be realized.

Further, in a glass substrate as well, cracks generated by volume expansion due to the phase transition of a crystal layer may propagate, leading to sudden damage.

A thickness dimension D of a glass plate having high toughness and high flexibility is, for example, 1 μm to 100 μm. The thickness dimension D indicates, for example, an average thickness dimension. Further, in preparing the glass substrate, in order to obtain a glass tape having sufficiently high toughness and sufficiently high flexibility, the thickness dimension D of the glass tape is preferably 4 μm to 50 μm, more preferably 10 μm to 30 μm.

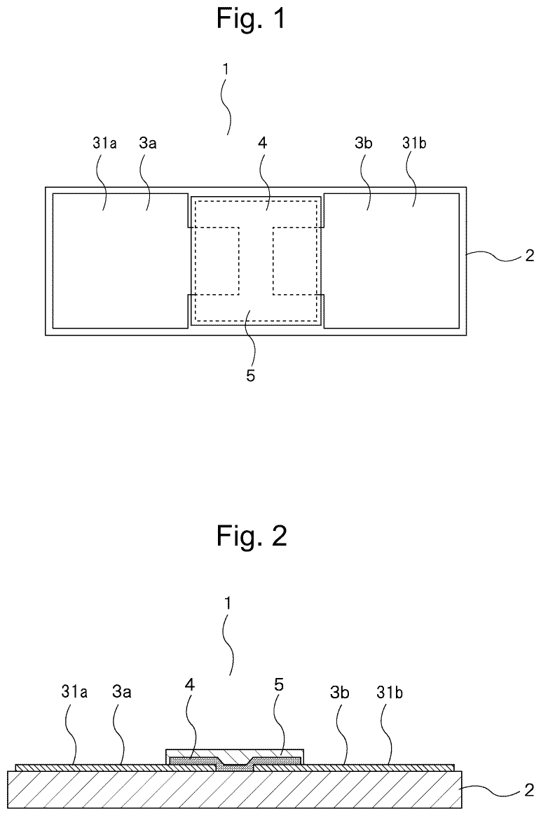

Based on situations such as described above, the resistor according to an embodiment of the present invention will be described with reference to FIG. 1 to FIG. 11.

FIG. 1 to FIG. 4 illustrate a resistor, and FIG. 5 to FIG. 11 show evaluation results of the resistor. It should be noted that, in FIG. 1 to FIG. 4, a scale of each member is changed as appropriate in order to illustrate each member in a size enabling recognition for the purpose of description.

As illustrated in FIG. 1 and FIG. 2, a resistor 1 includes an insulating substrate 2, a pair of electrode layers 3a and 3b, a resistive film 4, and a protective film 5.

In this embodiment, the resistor 1 is a thermosensitive resistance element that functions as a temperature sensor, and is a thin-film thermistor. It should be noted that resistors need only include a resistive film regardless of characteristics thereof, and include those that simply have electrical resistance, thermistors with negative temperature coefficients or positive temperature coefficients, and the like.

The resistor 1 is formed into a substantially rectangular parallelepiped shape, and has a lateral dimension of 6.0 mm, a longitudinal dimension of 2.0 mm, and a total thickness dimension of 60 μm. The shape and the dimensions are not particularly restricted and can be selected as appropriate in accordance with the application.

The insulating substrate 2 has a substantially rectangular shape and is an inorganic material substrate having insulation properties. Specifically, the insulating substrate 2 is a glass substrate formed from a glass material and contains 40 to 80% silicon dioxide (SiO₂).

Specifically, the glass substrate contains a composition of, by mass %, 60 to 70% SiO₂, 10 to 20% B₂O₃, 0 to 10% Al₂O₃, 0 to 10% CaO, 0 to 10% ZnO, and 0<1% Sb₂O₃. Further, the glass substrate can be configured to contain a composition of, by mass %, 55 to 65% SiO₂, 13 to 18% Al₂O₃, 8 to 13% B₂O₃, and 10 to 20% RO(MgO+CaO+SrO+BaO). This insulating substrate 2 has a thickness dimension of 1 μm to 100 μm, specifically 10 μm to 50 μm, and is preferably formed by being reduced in thickness to 30 μm or less.

Further, the insulating substrate 2 has flexibility and a Young's modulus of 250 GPa or less, making it possible to, for example, measure temperature by placing the resistor 1 along a curved surface. Furthermore, as a condition for preparing the insulating substrate 2 so as to have a thickness dimension of 50 μm or less, the present inventors conducted various investigations and selection work during the development process, focused on the Young's modulus of the insulating substrate 2, and found the value of Young's modulus being 250 GPa or less.

Furthermore, a linear expansion coefficient of the insulating substrate 2 is preferably 3×10⁻⁶/° C. to 18×10⁻⁶/° C., more preferably 5×10⁻⁶/° C. to 12×10⁻⁶/° C. The linear expansion coefficient is set within this range, making it possible to suppress damage to the resistive film 4 due to dimensional changes caused by temperature changes when forming the resistive film 4 or when using the resistor 1.

The pair of electrode layers 3a and 3b are formed on the insulating substrate 2, are portions to which the resistive film 4 is electrically connected, and are disposed so as to face each other with a predetermined spacing. Specifically, the pair of electrode layers 3a and 3b are each formed by depositing a thin metal film by a sputtering method and, as a metal material thereof, a precious metal such as platinum (Pt), gold (Au), silver (Ag), palladium (Pd), or ruthenium (Ru), or an alloy thereof, such as an Ag—Pd alloy, for example, is applied. It should be noted that, in this embodiment, the electrode layers 3a and 3b are formed under the resistive film 4, but may be formed on or within the resistive film 4. Further, specifically, the electrode layers 3a and 3b are platinum, have a content of at least one of oxygen and nitrogen of 0.01 wt % or more and 4.9 wt % or less, and have crystallinity.

The resistive film 4 is a thermosensitive thin film, and is a thin film of a thermistor composed of an oxide semiconductor having a negative temperature coefficient. The resistive film 4 is deposited on the insulating substrate 2 and on the electrode layers 3a and 3b by a sputtering method so as to span across the electrode layers 3a and 3b, and is electrically connected to the electrode layers 3a and 3b.

The resistive film 4 is constituted by two or more elements selected from transition metal elements such as manganese (Mn), nickel (Ni), cobalt (Co), and iron (Fe), and is constituted by a thermistor material containing, as a main component, a composite metal oxide having a spinel structure. Further, subcomponents may be contained for improving characteristics, and the like. Compositions and contents of the main components and the subcomponents can be determined as appropriate in accordance with desired characteristics. In this embodiment, the thermosensitive thin film of the resistive film 4 is a metal oxide of Mn—Co—Ni.

It should be noted that the resistive film 4 can also be formed of a metal nitride. In this case, the metal nitride may be a nitride represented by general formula MxAyNz (where M represents Ta and A represents Al, 0.67≤x≤0.7, 0.01≤y≤0.02, 0.28≤z≤0.32, and x+y+z=1).

The protective film 5 covers a region where the resistive film 4 is formed, and covers the electrode layers 3a and 3b by forming exposed portions 31a and 31b so that at least part of the electrode layers 3a and 3b is exposed. The protective film 5 can be formed by depositing silicon dioxide (SiO₂), silicon nitride (Si₃N₄), or the like by a sputtering method, or lead glass, borosilicate glass, lead borosilicate glass, or the like can be formed by a printing process. Further, the protective film 5 can be configured to have a multi-layer structure by laminating two or more materials selected from the above-described materials. That is, the protective film 5 can be configured to have a multi-layer structure by laminating different materials. For example, the protective film 5 can be configured to have a two-layer structure by laminating silicon dioxide (SiO₂) and borosilicate glass.

The protective film 5 is configured to have a multi-layer structure, making it possible to protect the resistive film 4, reduce fluctuation in a resistance value with respect to a surrounding temperature environment, and enhance an effect of suppressing fluctuation in characteristics.

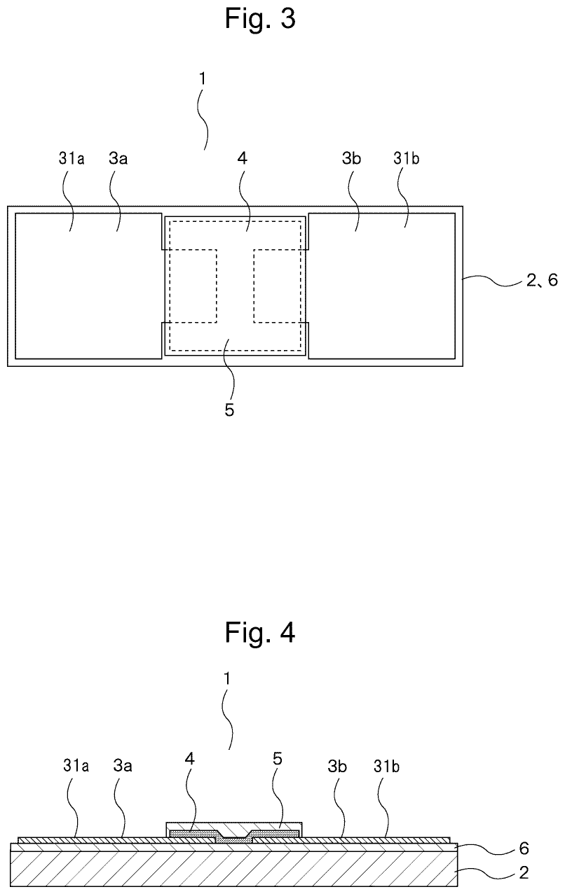

Next, a resistor according to another embodiment will be described with reference to FIG. 3 and FIG. 4. It should be noted that the same or corresponding portions as those of the resistor illustrated in FIG. 1 and FIG. 2 are denoted by the same reference signs, and redundant descriptions are omitted.

The embodiment includes a barrier layer 6 formed on the insulating substrate 2. Specifically, the barrier layer 6 that prevents thermal diffusion between the insulating substrate 2 and the resistive film 4 is interposed between the insulating substrate 2 and the electrode layers 3a and 3b as well as the resistive film 4. In this case, the barrier layer 6 can be formed by depositing silicon dioxide (SiO₂), silicon nitride (Si₃N₄), or the like by a sputtering method.

Next, evaluation results of the resistor according to the above-described embodiment will be described with reference to FIG. 5 to FIG. 11.

The resistor 1 configured as described above was evaluated in a case of being left within the operating temperature range, as previously mentioned. FIG. 5 shows a microscope image of the resistor 1 with a glass substrate observed from a side surface after the resistor 1 was left under a 150° C. temperature environment for 1,000 hours. Further, FIG. 6 shows a microscope image of the resistor 1 with a glass substrate observed from a side surface after the resistor 1 was left under a 200° C. temperature environment for 1,000 hours.

As is clear from the drawings, it can be seen that, in the glass substrate of this embodiment, deformation due to phase transition within the operating temperature range was suppressed and strength reduction was alleviated. It should be noted that the operating temperature range is the temperature range in a case in which the resistor 1 is used in various situations, and a range of −80° C. to 300° C. is assumed.

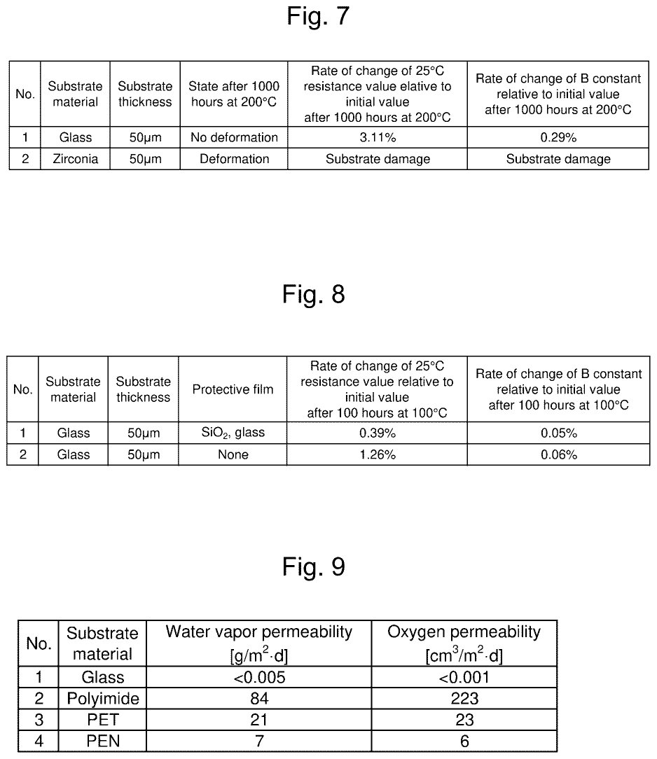

FIG. 7 is a table of an evaluation of the glass substrate of this embodiment (Sample No. 1) and a commonly used zirconia substrate (Sample No. 2). The table indicates appearances and rates of change of resistance values and B constants relative to initial values after leaving the resistors under a 200° C. temperature environment for 1,000 hours. According to the glass substrate of this embodiment, it can be seen that there was no deformation, fluctuation in the resistance value was suppressed to 3.11% even after 1,000 hours, and the B constant hardly changed.

FIG. 8 is a table showing evaluations of the glass substrate of this embodiment in a case in which the protective film was formed (Sample No. 1) and in a case in which the protective film was not formed (Sample No. 2). In a case in which the protective film was formed, the glass substrate had a two-layer structure of silicon dioxide (SiO₂) and borosilicate glass as the glass. The table indicates the rates of change of the resistance values and the B constants relative to the initial values after leaving the resistors under a 100° C. temperature environment for 100 hours. It can be seen that forming the protective film makes it possible to suppress fluctuation in the resistance value.

FIG. 9 is a table showing water vapor and oxygen permeabilities of the glass substrate (Sample No. 1) of this embodiment and typical resin films. The table shows the water vapor permeabilities and the oxygen permeabilities of polyimide (Sample No. 2), polyethylene terephthalate (PET; Sample No. 3), and polyethylene naphthalate (PEN; Sample No. 4) as the resin films. Glass had very low permeabilities for both water vapor and oxygen as compared with those of resin films. Accordingly, in a case in which a glass substrate is used in a resistor, suppression of characteristic fluctuation and improvement in reliability can be expected.

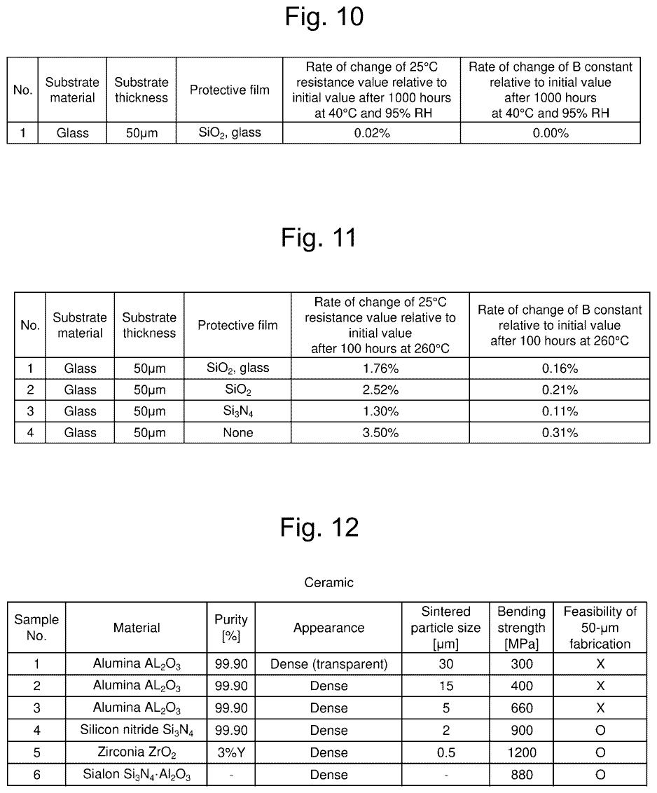

FIG. 10 is a table showing effects in a case in which the protective film was formed on the glass substrate of this embodiment (Sample No. 1). This is a case in which the protective film had a two-layer structure of silicon dioxide (SiO₂) and borosilicate glass. The table shows the rates of change of the resistance value and the B constant relative to the initial values after leaving the resistor under a 40° C. and 95% RH environment for 1,000 hours. It can be seen that the fluctuations in both the resistance value and the B constant were very small.

FIG. 11 shows the rates of change of the resistance values and the B constants of the glass substrate of this embodiment in a case in which the protective film had a two-layer structure of silicon dioxide (SiO₂) and borosilicate glass (Sample No. 1), in a case in which the protective film was silicon dioxide (SiO₂) only (Sample No. 2), in a case in which the protective film was silicon nitride (Si₃N₄) only (Sample No. 3), and in a case in which the protective film was not formed (Sample No. 4). It can be seen that, in the rates of change of the resistance values and the B constants relative to the initial values after leaving the resistors under a 260° C. temperature environment for 100 hours, these fluctuations can be suppressed by forming the protective film.

Further, silicon nitride (Si₃N₄) was used as the protective film (Sample No. 3), making it possible to effectively reduce the fluctuations in the rates of change of the resistance values and the B constants.

As described above, according to this embodiment, it is possible to reduce the thickness of the insulating substrate 2, suppress deformation, suppress fluctuation in characteristics, and thus provide the resistor 1 having high precision.

It should be noted that the present invention is not limited to the configurations of the above-described embodiments, and various modifications are possible without departing from the gist of the invention. Further, the above-described embodiments are presented as examples, and are not intended to limit the scope of the invention. These new embodiments can be implemented in various other forms, and various omissions, substitutions, and changes can be made. These embodiments and modifications thereof are included in the scope and gist of the invention, and in the scope of the invention and its equivalents described in the claims.

Descriptions of Reference Numerals

| | |
|---|---|
| 1 | Resistor |
| 2 | Insulating substrate |
| 3a, 3b | Electrode layer |
| 31a, 31b | Exposed portion |
| 4 | Resistive film |
| 5 | Protective film |
| 6 | Barrier layer |

1. A resistor comprising:
an inorganic material substrate that has insulation properties, flexibility, and a thickness dimension of 1 μm to 100 μm, and suppresses deformation due to phase transition within an operating temperature range;
a resistive film formed on the inorganic material substrate;
at least one pair of electrode layers electrically connected to the resistive film; and
a protective film that covers a region where the resistive film is formed and forms an exposed portion so that at least part of the at least one pair of electrode layers is exposed.

2. The resistor according to claim 1, wherein
the inorganic material substrate has a Young's modulus of 250 GPa or less and a linear expansion coefficient of 3×10⁻⁶/° C. or more and 18×10⁻⁶/° C. or less.

3. The resistor according to claim 1, wherein
the inorganic material substrate is a glass substrate or a ceramic substrate.

4. The resistor according to claim 1, wherein
a barrier layer is formed on the inorganic material substrate.

5. The resistor according to claim 1, wherein
the protective film is silicon dioxide or silicon nitride.

6. The resistor according to claim 1, wherein
the protective film has a multi-layer structure obtained by laminating different materials.

7. The resistor according to claim 6, wherein
the protective film has a two-layer structure of silicon dioxide and glass.

8. The resistor according to claim 3, wherein
the glass substrate contains a composition of, by mass %, 60 to 70% SiO₂, 10 to 20% B₂O₃, 0 to 10% Al₂O₃, 0 to 10% CaO, 0 to 10% ZnO, and 0<1% Sb₂O₃.

9. The resistor according to claim 3, wherein
the glass substrate contains a composition of, by mass %, 55 to 65% SiO₂, 13 to 18% Al₂O₃, 8 to 13% B₂O₃, and 10 to 20% RO(MgO+CaO+SrO+BaO).

10. The resistor according to claim 1, wherein
the resistive film is a thermosensitive thin film.

11. The resistor according to claim 10, wherein
the thermosensitive thin film is metal oxide or metal nitride.

12. The resistor according to claim 11, wherein
the metal oxide is a Mn—Co—Ni oxide.

13. The resistor according to claim 11, wherein
the metal nitride is composed of a nitride represented by general formula MxAyNz (where M represents Ta and A represents Al, 0.67≤x≤0.7, 0.01≤y≤0.02, 0.28≤z≤0.32, and x+y+z=1).

14. The resistor according to claim 1, wherein
the at least one pair of electrode layers is platinum, has a content of at least one of oxygen and nitrogen of 0.01 wt % or more and 4.9 wt % or less, and has crystallinity.

15. The resistor according to claim 2, wherein
the inorganic material substrate is a glass substrate or a ceramic substrate.

16. The resistor according to claim 2, wherein
a barrier layer is formed on the inorganic material substrate.

17. The resistor according to claim 2, wherein
the protective film is silicon dioxide or silicon nitride.

18. The resistor according to claim 2, wherein
the protective film has a multi-layer structure obtained by laminating different materials.
